(19) United States
(12) Patent Application Publication
(10) Pub. No.: US 2014/0317992 A1
(43) Pub. Date: Oct. 30, 2014

(54) HOVERING FISHING LURE ASSEMBLY

(71) Applicant: Christopher James Morgan, Fayetteville, NC (US)

(72) Inventor: Christopher James Morgan, Fayetteville, NC (US)

(21) Appl. No.: 13/871,112

(22) Filed: Apr. 26, 2013

(51) Int. Cl. A01K 85/08

(52) U.S. Cl. CPC A01K 85/08
USPC 43/42.49

(57) ABSTRACT

The present invention is a fishing look delivery device for attaching a fishing lure and allowing it to hover above the water such as a dragonfly or other insect would hover over a body of water. A flotation body with a steel or carbon fiber wire attached flexible enough for the wire to sway but not dip into the water from the weight of the lure.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to fishing lures. In particular the present invention relates to an assembly for attaching a fishing lure in a manner that it hovers over the water in a natural manner during use.

2. Description of Related Art

The use of a fishing lure attempts to present to a fish a lure that mimics in some manner a natural bait such as a dragonfly. Known lures include artificial replicas of natural or natural appearing baits and also provide devices for attaching live baits for presentation to attract and capture a fish during the process of fishing. Since bait in their natural habitat appear as waterborne on top of water and in the air over the water and can appear as a flying, swimming, dormant injured or the like bait, numerous devices and lures have been invented to adapt lures for use in finish. One particularly difficult bait to replicate is the bait that hovers over the water such as a dragonfly. The dragonfly can hover over a few inches over the water and be stationary or move about as it flies. Replicating that movement to date has not been successful. Pitching lures during casting such as fly fishing keeps the lure in the air only for a few seconds and while it mimics a fly it doesn't come closest to mimicking a hovering bait. One attempt at creating a hovering bait is the use of a counterweighted float is shown in U.S. Pat. No. 6,955,005 wherein a float is used to hold a lure which has the fishing line attached directly to the lure. In some embodiments there is a short rigid stem described as long enough to hold the lure above any weeds. There is no description which indicates it is designed to allow the lure to act as if it is actually flying nor at a height which would mimic flying rather since the lure is attached to a rigid stem the lure would move as the float moves bobbing up and down with the movement of the water and float. While successful at getting a lure off the water it is a total failure to mimic a hovering insect. Accordingly, a lure assembly wherein the lure moves closer to a realistic hovering insect would be a tremendous improvement in the art of presenting a fishing lure as a fish attractant.

### BRIEF SUMMARY OF THE INVENTION

The present invention relates to a floating assembly for attaching a fishing lure where the lure is presented when the assembly is floating such that it appears to fly independent of the float in a natural manner.

Accordingly, the present invention in one embodiment is a device for floating on a body of water and attaching a fishing lure such that the lure appears to be hovering above the surface of the body of water and independent of the device comprising:

a) a floating body having a first end and a second end, a top surface which floats above the surface of the body of water and a bottom surface which floats at or below the surface of the body of water in use ;

b) an eyelet for attaching a fishing line directly to the floating body first end;

c) a wire which is positioned on the upper surface of the device and of a stiffness that when a fishing lure is attached at an opposite end, the wire holds the lure above the water and flexes in response to movement of the body.

### BRIEF DESCRIPTION OF THE DRAWINGS

FIG. 1 is a side view of the body.

FIG. 2 is a back view of the body.

FIG. 3 is a bottom view of the body.

FIG. 4 is a side view of the device of the invention with a fishing lure attached and a cut out view of the inside of the body.

FIG. 5 is a perspective view of the device of the invention with a lure attached.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### Definitions

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “floating on a body of water” refers to a device which is capable of floating at a surface of a body of water for the purpose of catching fish. While the device will operate properly in any body of water since the purpose of the device is to catch fish slightly suspending under surface on such body with catchable fish is intended. This can include a lake, river, ocean, sea or the like. It is assumed that it is a body of water that the fish would be attracted to a fishing lure which hovers over the surface of the body of water.

As used herein the phrase “hovering above the surface of the body of water” refers to an action which mimics an insect such as a dragonfly hovering just slightly above the water level up to about 12 inches above the surface of the water. Hovering requires the insect lure to be able to move up, down, left and right relative to the device body. As used herein the term “independent” as it refers to a hovering lure refers to the ability to move left right up and down while as the body of the device moves about in the water it does stay relatively close to the body. Therefore, it is not completely independent in the sense that it is not connected to the body only that it has the ability to move up, down left and right relative to the device body.

As used herein the term “fishing lure” refers to a fishing artificial or natural bait (with hook, etc., designed for fishing) that would if it were in a natural environment hover over the surface of the water. Dragonflies and other insects are well known in the fishing industry and those and any other hovering insects could be utilized herein.

As used herein the term “floating body” refers to a device which when placed in a body of water floats on the surface of the water with a top surface which floats above the surface of the water and a bottom surface which floats at or below the surface of the water. The device will have an attached wire as described later and as such the body must be of a shape that can be pulled easily through the water and be weighted such that the wire and an attached lure will not tip the device over and place the lure in the water. In the examples in the figures the body is about 3.75 inches in length and about 2.75 inches wide including the wing stabilizers. It is clear that one could make the device half the size, double the size or any size convenient. Such sizing is then within the skill in the art in view of the present invention disclosure.

The body can be made to float by making it of any convenient material and/or design. So for example, foams such as expanded polystyrene foam, hollow bodies, wood and the like could be utilized. The selection of materials to make the body is within the skill in the art in view of this disclosure. Other materials could include cork or the like.

In one embodiment, the body is tapered from the front or first end to the back (an example is utilized in the Figures). In order to add stability to the body, help it glide through the water and the like, a keel can be added to the bottom of the body. In another embodiment, a pair of wing structures can be added at the left and right sides of the body as stabilizers roughly at the waterline when the device is in use.

As used herein an “eyelet” is a device known in the fishing trade for attaching a fishing line. The eyelet is placed at the floating body first end such that when a fishing line is attached the floating body can be pulled through the water. Thus the device can be placed in the water or cast into the water and the fishing line used to retrieve it. Unlike other devices the fishing line is not attached directly to the fishing lure. The fishing lure is attached to the semi-flexible wire of the present invention.

As used herein a “wire” is a piece of wire having a stiffness that when a fishing lure is attached to an opposite end of the wire and the first end attached to the body, the wire holds the lure above the water and flexes (bounces and swings) in response to the movement of the body and in some embodiments will respond to wind. The lure remains a relative distance from the body but because the lure can swing left and right and bounce up and down the lure can move at least semi-independent of the body of the device giving the lure a natural movement. So the wire stiffness is a factor of three things: the length of the wire that sticks of out the body, the thickness (diameter) of the wire and the material the wire is made from. In general steel, stainless steel or carbon fiber or the like will be used and wires will be stiff but have some bend from their own weight. The length of the wire that sticks out of the body will be from about 3 or 4 inches to about 11 to 18 inches. In one embodiment, it is about 12 inches long. In one embodiment, it is at least 5 inches in another at least 7 inches in length. In one embodiment the wire is 0.025 inches in diameter but in some instances it can be greater or smaller. The wire can in one embodiment be from about 0.0125 to about 0.050 inches. If the wire is to short is does not move, if it is too thick it does not move. If it is too long it bends so much the lure ends up in the water. One skilled in the art could start with a piece of stainless steel wire 0.025 inches in diameter and 12 inches long observe the motion of that wire and determine what other combinations of length, thickness (diameter) and materials will behave similarly. The materials of the wire can be metals such as steel, stainless steel, carbon fiber plastic or the like as long as they meet the required stiffness and flexibility as taught above. The wire could have additional length for inserting into the body for example, 1-5 inches of length.

The wire is attached to the body by any convenient method so it can be inserted into the body and molded or glued into place. In one embodiment, it passes through the body and attaches to a back of the eyelet. The position of the wire is on the upper surface (as shown in the Figures) which allows for it to be counterweighted in the front. So positioning it somewhere in the back half of the body is one embodiment though any place where the device is balance (with or without weights) is contemplated.

The selected fishing lure, such as a dragonfly lure shown in the Figures is attached to the second free end of the wire away from the body of the device. It can be taped or clipped in place or any convenient method but should be such it can easily be replaced if the lure is lost or damaged or just a change is desired A hook for catching fish could be attached to the wire or the lure.

In practice the lure is attached to the wire as the lure body is pulled through the water, jerked on or the like the lure bounces and swings on the wire giving it a natural and in the case of a fish appetizing look to it.

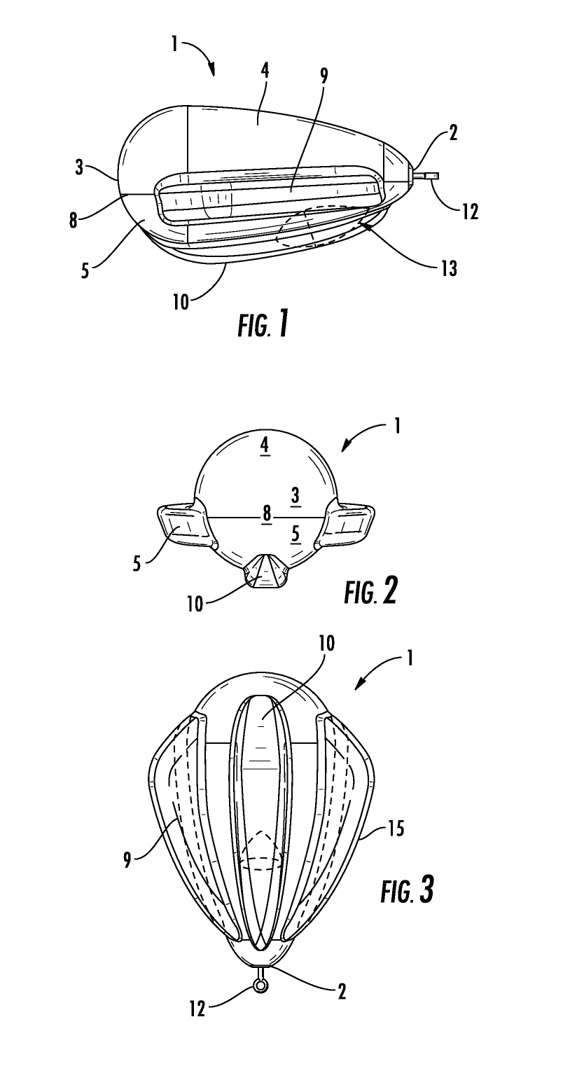

Now referring to the drawings for further understanding of the present invention, FIG. 1 is a side view of a representative example of a body of the present invention device. In this view, body 1 has a first front end 1 and a second back end 2. As can be seen from the drawing the body 1, tapers from first end 2, to second end 3 being larger at the second end. The body has a top side 4, and a bottom side 5, with a line 8 that represents about where the body 1 would float on the surface of a body of water. This embodiment of a body has left and right wings and a right wing 9 is shown right at waterline 8. A keel 10 is also shown. Both the keel and the wings help stabilize the body 1 in the water as it is pulled through the water by a fishing line 11 attached to eyelet 12. A cavity 13 for introducing a compensation weight is shown in dashed line as it is inside body 1. Selection of the weight is based on balancing the wire and lure to keep it from tipping over due to weight. This could be a fixed weight or a replaceable/changeable weight. Clearly regular fishing weights or a weight as desired could be utilized.

FIG. 2 is a rear view of body 1. In the view both right 9 and left 15 wings are shown.

FIG. 3 is a bottom side view which allows the wings 9 and 15 and keel 10 to be fully seen in body 1.

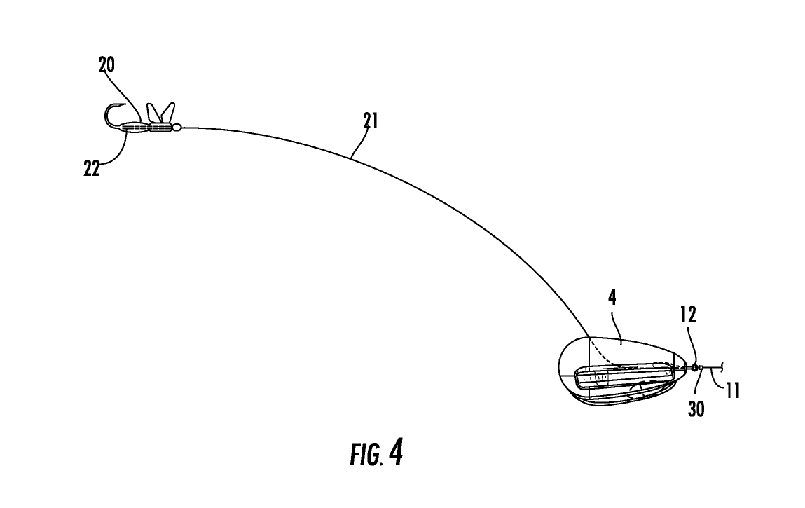

FIG. 4 is a side view of the present invention device with an attached dragonfly lure 20 attached to wire 21 at opposite wire end 22. The lure is applied using any desired method such as tape, sliding it on the wire and the like. In this view a swivel 30 has been added where the fishing line 11 attaches and it can be seen that wire 21 enters the top 4 of the body 1 at the back half and attaches to eyelet 12 by passing all the way through body 1.

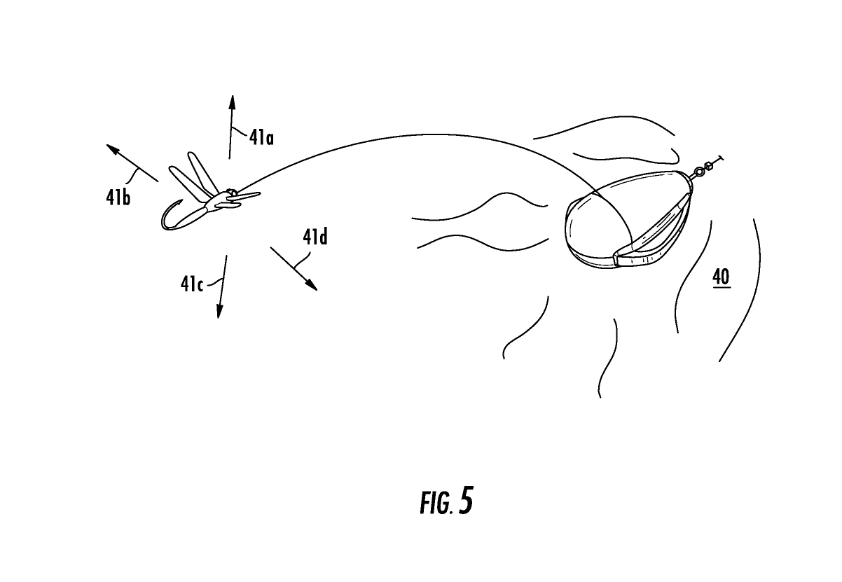

Lastly FIG. 5 is a perspective view of the device sitting on the surface of a body of water 40. Movement arrows 41a, 41b, 41c and 41d (4 degrees of motion) indicate the swing and bobbing motions which the lure 20 can have due to placement on the wire end.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A device for floating on a body of water and attaching a fishing lure such that the lure appears to be hovering above the surface of the body of water and independent of the device comprising:
a) a floating body having a first end and a second end, a top surface which floats above the surface of the body of water and a bottom surface which floats at or below the surface of the body of water in use;
b) an eyelet for attaching a fishing line directly to the floating body first end;
c) a wire which is positioned on the upper surface of the device and of a stiffness that when a fishing lure is attached at an opposite end, the wire holds the lure above the water and flexes in response to movement of the body.

2. The device according to claim 1 wherein the body is tapered from the first end to the second end.

3. The device according to claim 1 wherein there is keel on the bottom surface of the body.

4. The device according to claim 1 wherein there is a pair wings on opposite sides of the body.

5. The device according to claim 1 wherein there is a cavity in the body for placing weights.

6. The device according to claim 1 wherein the wire passes through the floating body and is attached to the eyelet.

7. The device according to claim 1 wherein the wire enters the body towards the second end of the body.

8. The device according to claim 1 wherein there is a fishing lure attached to the opposite end of the wire.

9. The device according to claim 1 wherein the wire has a diameter from about 0.0125 inches to about 0.050 inches.

10. The device according to claim 1 wherein the body is at least partially made of polystyrene foam.

11. The device according to claim 1 having a fishing line attached to the eyelet.

12. The device according to claim 1 wherein the wire is replaceable.

13. The device according to claim 1 wherein the wire is made of steel, stainless steel or carbon fiber.

14. The device according to claim 1 wherein the wire is a stainless steel wire having a length of about 12 inches that sticks out of the body and a diameter of about 0.025 inches.

15. The device according to claim 1 wherein there is a swivel attached to the eyelet.

16. The device according to claim 1 wherein an additional length of the wire is embedded in the body.
